(19) United States
(12) Patent Application Publication
(10) Pub. No.: US 2012/0068834 A1
(43) Pub. Date: Mar. 22, 2012

(54) SYSTEM, APPARATUS, AND METHOD PROVIDING 3-DIMENSIONAL TACTILE FEEDBACK

(75) Inventors: Hyung Kew LEE, Gunpo-si (KR); Joon Ah Park, Seoul (KR)

(73) Assignee: SAMSUNG ELECTRONICS CO., LTD., Suwon-si (KR)

(21) Appl. No.: 13/232,649

(22) Filed: Sep. 14, 2011

(30) Foreign Application Priority Data
Sep. 14, 2010 (KR) 10-2010-0089943

(51) Int. Cl. G08B 6/00

(52) U.S. Cl. 340/407.1

(57) ABSTRACT

Provided is a three-dimensional (3D) tactile sensation transferring system, apparatus, and method. The 3D tactile sensation transferring apparatus may include a stationary unit and a movable unit that is accommodated in the stationary unit and moves in at least one horizontal direction relative to a surface of a body for moving in the at least one horizontal direction while touching the surface of the body. The movable unit may be moved in the at least one direction by an actuator included in the 3D tactile sensation transferring apparatus.

### CROSS-REFERENCE TO RELATED APPLICATIONS

This application claims the priority benefit of Korean Patent Application No. 10-2010-0089943, filed on Sep. 14, 2010, in the Korean Intellectual Property Office, the disclosure of which is incorporated herein by reference.

### BACKGROUND

1. Field

One or more embodiments relate to a system, apparatus, and method to transfer a three-dimensional (3D) force vector to a physical sensing organ of a body, and more particularly, to a system, apparatus, and method for expressing a force vector, through a physical motion using at least three different dimensional force applicators, to a sensing organ of a human body sensitive to tactile input.

2. Description of the Related Art

Recently, devices that remotely manipulate robots to perform predetermined operations are widely used as industrial and medical devices. The devices relate to a teleoperation field.

When a human manipulates the robot, a physical quantity that represents force including a tension currently applied to the robot, a load, and the like, may not be accurately fed back to a user, e.g., a human user, as a tactile sensation, since force is transferred uni-directionally. Such fed back forces do not represent a force vector in more than one or two dimensions.

Conventionally, there has been a large amount of studying on force feedback to a user corresponding to the bending of joints of robots or corresponding to a load in a direction that the robot moves towards, e.g., a fed back force in the opposite direction the robot moves. As further explained below, such forces are referred to as kinaesthesia forces. Conversely, a relatively small number of studies have been conducted on force feedback corresponding to an intuitional physical quantity by transferring tactile sensations to a surface of the user's body, such as applied to the skin of the human user.

When, in addition to the manipulating of the robot, a virtual physical force is transferred to a hand or the skin of the user, to enable the user to feel a tactile sensation with respect to a computing simulation, a more realistic simulation may be experienced. Such examples include virtual physical forces that aim to educate or entertain.

Physical devices, and corresponding technologies, that transfer a force or tactile sensation are referred to as haptic feedback devices or technologies.

### SUMMARY

Foregoing disadvantages have been overcome and/or other aspects are achieved by providing a three-dimensional (3D) tactile sensation transferring apparatus, the apparatus may include a stationary element, a movable element being accommodated within an enclosure of the stationary element, and configured to move along at least one non-orthogonal axis relative to a surface of a body to transfer a horizontal component of a multi-dimensional force vector, as a tactile sensation, to the surface of the body when the surface of the body is in contact with the movable element, and an actuator configured in the stationary element and to apply a movement force to the movable element along the one non-orthogonal axis when the actuator is activated.

The actuator may further include an elastic body that provides a restoring force to the movable element to force the moveable element toward an equilibrium position relative to an interior of the stationary element at least when the actuator is not activated.

The actuator may apply the movement force along the one non-orthogonal axis according to changes in air pressure within the actuator. Still further, the actuator may be a solenoid generating an electromagnetic force through interaction between the actuator and the movable element to apply the movement force to the moveable element along the one non-orthogonal axis. Additionally, the actuator may be a bimorph including a piezo-electric element layer whose change in shape controls the application of the movement force to the moveable element along the one non-orthogonal axis.

Movement of the movable element within the enclosure of the stationary element may be representative of a three-dimensional (3D) force vector of a feedback signal representing a load being applied to the body by a teleoperator, including the stationary element, moveable element, and the actuator, during a teleoperation.

Here, the apparatus may further include a teleoperation controller to control operation of plural actuators configured to apply respective movement forces to the movable element to transfer the 3D force vector, as the tactile sensation, to the surface of the body during the teleoperation, and a kinaesthesia force applicator configured to apply kinaesthesia forces, distinct from the 3D force vector, by the teleoperator to the body during the teleoperation.

The actuator may include a first actuator configured to apply a first movement force to the movable element along an X-axis direction horizontal relative the surface of the body, upon respective activation, a second actuator configured apply a second movement force to the movable element along a Y-axis direction horizontal relative to the surface of the body, upon respective activation, and a third actuator configured to apply a third movement force to the movable element along a Z-axis direction orthogonal to the X- and Y-axes, upon respective activation.

Here, the apparatus may further include a teleoperation controller to control operation of a plurality of the first, second, and third actuators configured to apply respective movement forces to respective movable elements, each moveable element to transfer a respective 3D force vector as a respective tactile sensation to different surfaces of the body by a teleoperator, including the plurality of first, second, and third actuators, during the teleoperation, and a kinaesthesia force applicator configured to apply kinaesthesia forces, distinct from each of the 3D force vectors, by the teleoperator to the body during the teleoperation.

Foregoing disadvantages have been overcome and/or other aspects are achieved by providing a three-dimensional (3D) tactile sensation transferring method of a 3D tactile sensation transferring apparatus that may include a stationary element, a movable element being accommodated within an enclosure of the stationary element, and configured to move along at least one non-orthogonal axis relative to a surface of a body to transfer a horizontal component of a multi-dimensional force vector, as a tactile sensation, to the surface of the body when the surface of the body is in contact with the movable element, and an actuator configured in the stationary element and to apply a movement force to the movable element along the one non-orthogonal axis when the actuator is activated, the method may include activating the actuator, and moving the moveable element based upon a movement force applied by the actuator to the moveable element in the direction of the one non-orthogonal axis upon activation of the actuator.

The method may further include providing a restoring force to the movable element, using an elastic body included in the actuator, to force the moveable element toward an equilibrium position relative to an interior of the stationary element at least when the actuator is not activated.

The moving of the moveable element may include applying the movement force to the movable element along the one non-orthogonal axis according to changes in air pressure within the actuator. The moving of the moveable element may include applying the movement force to the movable element along the one non-orthogonal axis using a solenoid electromagnetic force generated through interaction between the actuator and the movable element. The moving of the moveable element may include moving the movable element using a bimorph including a piezo-electric element layer whose change in shape controls the application of the movement force to the moveable element along the one non-orthogonal axis.

Movement of the movable element within the enclosure of the stationary element may be representative of a three-dimensional (3D) force vector of a feedback signal representing a load being applied to the body by a teleoperator, including the stationary element, the moveable element, and the actuator, during a teleoperation.

Here, the method may further include controlling operation of plural actuators configured to apply respective movement forces to the movable element to transfer the 3D force vector, as the tactile sensation, to the surface of the body during the teleoperation, and applying kinaesthesia forces, distinct from the 3D force vector, by the teleoperator to the body during the teleoperation.

The method may include controlling an application of a first movement force to the movable element along an X-axis direction horizontal relative the surface of the body, controlling an application of a second movement force to the movable element along a Y-axis direction horizontal relative to the surface of the body, and controlling an application of a third movement force to the movable element along a Z-axis direction orthogonal to the X- and Y-axes.

Here, the method may further include controlling operation of a plurality of the first, second, and third actuators configured to apply respective movement forces to respective movable elements, each moveable element to transfer a respective 3D force vector as a respective tactile sensation to different surfaces of the body by a teleoperator, including the plurality of first, second, and third actuators, during the teleoperation, and applying kinaesthesia forces, distinct from each of the 3D force vectors, by the teleoperator to the body during the teleoperation.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIGS. 1A and 1B are diagrams illustrating a three-dimensional (3D) tactile sensation transferring apparatus and system, respectively, according to one or more embodiments;

FIG. 2 is an exploded perspective view of a 3D tactile sensation transferring apparatus, according to one or more embodiments;

FIG. 3 is a cross-sectional view of a 3D tactile sensation transferring apparatus, according to one or more embodiments;

FIG. 4 is a diagram illustrating an actuator of a 3D tactile sensation transferring apparatus that uses air pressure, according to one or more embodiments;

FIGS. 5A, 5B, and 5C are diagrams illustrating a process where a moveable unit of a 3D tactile sensation transferring apparatus is moved by an actuator, such as the actuator of FIG. 4, according to one or more embodiments;

FIG. 6 is a diagram illustrating an actuator of a 3D tactile sensation transferring apparatus, the actuator being embodied by a solenoid, according to one or more embodiments;

FIGS. 7A, 7B, and 7C are diagrams illustrating a process where a moveable unit of a 3D tactile sensation transferring apparatus is moved by an actuator, such as the actuator of FIG. 6, according to one or more embodiments;

FIG. 8 is a diagram illustrating an actuator of a 3D tactile sensation transferring apparatus, the actuator being embodied by a bimorph including a piezo-electric element, according to one or more embodiments; and

FIGS. 9A, 9B, and 9C are diagrams illustrating a process for controlling the movement of actuators of a 3D tactile sensation transferring apparatus, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein, as various changes, modifications, and equivalents of the systems, apparatuses and/or methods described herein will be understood to be included in the invention by those of ordinary skill in the art after embodiments discussed herein are understood. Accordingly, embodiments are merely described below, by referring to the figures, to explain aspects of the present invention.

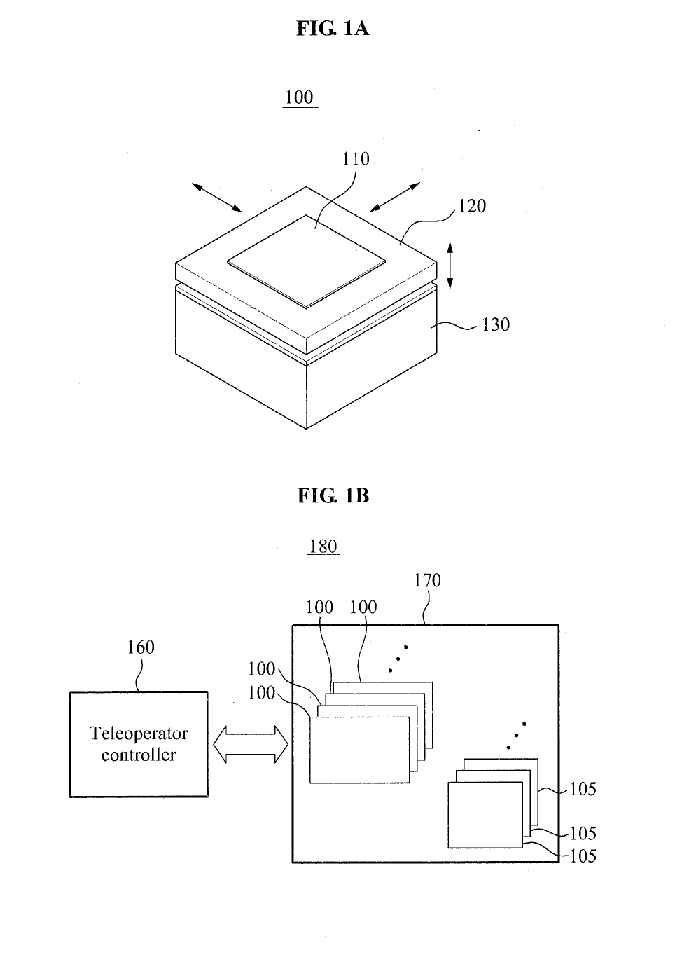

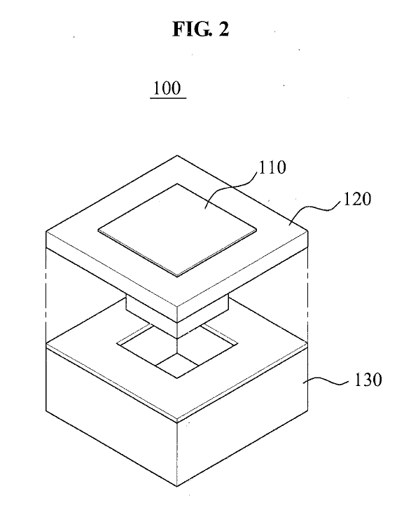

FIG. 1A illustrates a three-dimensional (3D) tactile sensation transferring apparatus 100, according to one or more embodiments.

The 3D tactile sensation transferring apparatus 100 may include a stationary unit 130 and a moveable unit that respectively moves in each of at least three-dimensions. The moveable unit, as only an example, may include a contact surface 110 and a frame 120.

The contact surface 110 of the moveable unit may transmit a tactile sensation through the sensed movement of the moveable unit when the moveable unit is touching the skin of a user, such as the surface of a finger of a human user. In one or more embodiments, the contact surface 110 may transfer such tactile sensation by modification of the contact surface 110. For example, the contact surface 110 may be controlled to move up and down in a Z-axis direction to transfer a tactile sensation of the up and down directions, that is, a tactile sensation of a Z-axis direction.

A frame 120 of the moveable unit may move back and forth, that is, in an X-axis direction, or may move left and right, that is, in a Y-axis direction to transfer a tactile sensation to surface of the user's body that is in contact with the contact surface 110.

The contact surface 110 may be constituted by material having a high friction coefficient, such as latex. The contact surface 110 may be fixed on the frame 120 and thus, a motion of the frame 120 may be transferred, as a tactile sensation, to a skin of a human who is in contact with the contact surface 110.

The frame 120 of the movable unit may be accommodated in the stationary unit 130. The stationary unit 130 may support the frame 120, while having a predetermined interval from the frame 120 and thus, may limit a scope of a motion of the frame 120.

As shown in FIG. 1B, the 3D tactile sensation transferring apparatus 100 may be attached to or may be included in a teleoperator 170 of a teleoperation system 180. When the 3D tactile sensation transferring apparatus 100 is included in the teleoperator 170, the stationary unit 130 may be incorporated into one or more kinaesthesia force applicators 105, if present, of the teleoperator 170. As further illustrated in FIG. 1B, one or more embodiments include one or more 3D tactile sensation transforming apparatuses 100, e.g., with the teleoperator 170 incorporating one or more 3D tactile sensation transforming apparatuses 100 for one or more fingers, including a thumb and index finger for tactile sensation of an object being held between the thumb and index finger. A 3D tactile sensation transforming apparatus 100 may be incorporated within the teleoperator 170 wherever there may be potential or available tactile sensations for the surface of the body of the user, as only an example. The teleoperator controller 160 may accordingly control the generation of the tactile sensations using each 3D tactile sensation transforming apparatus 100, in conjunction with control of the kinaesthesia force applications provided by any kinaesthesia force applicator 105. In an embodiment, the teleoperator controller 160 may also sense kinaesthesia force applications from the user, e.g., when the user is attempting to alter the yaw, roll, or pitch of a corresponding body part or held tool, and equally control the appropriate tactile sensation feedback to the user through a 3D tactile sensation transforming apparatus 100 and the corresponding kinaesthesia force applicator 105, e.g., to represent any opposing pressure to the user's desired alteration of yaw, roll, or pitch.

Embodiments of the present application are based upon a definition of the term ‘tactile’ with regard to force feedback or sensations sensed by a surface of a body, including at least non-vertical forces, i.e., non-orthogonal forces relative to the surface of the body, distinguished from kinaesthesia applied forces, such as provided by the kinaesthesia force applicator 105 of FIG. 1B. Haptic or touch feedback roughly includes two sensations; the first is feedback with respect to a force applied to a human bone/tissue/joint and the second is the herein described feedback with respect to a force applied to the surface of a body, such as to the skin of the user's body. The feedback forces with respect to the force applied to the bone/tissue/joints referred to herein as kinaesthesia applied forces, with the kinaesthesia force applicator 105 of FIG. 1B being a force feedback system that may apply forces according to yaw, roll, and pitch, for example, for orientation of a corresponding virtual appendage in 3D space or for providing feedback representing environmental conditions surrounding the virtual appendage in 3D space. Tactile sensations and tactile feedback, as defined herein, represent forces applied to the surface of a body and include at least horizontal, i.e., respectively, forces in the same plane as the surface of the body or non-orthogonal forces, and any vertical or orthogonal force applied to the surface of the body of the user. Additionally, such kinaesthesia force applicators 105 do not apply force according to a 3D vector, compared to one or more embodiments that provide tactile feedback through force vectors of horizontal and vertical components using a 3D tactile sensation transferring apparatus, such as the 3D tactile sensation transferring apparatus 100 of FIG. 1A.

Accordingly, in view of the above FIGS. 1A and 1B, one or more embodiments include using the 3D tactile sensation transferring apparatus 100 for teleoperation control, e.g., using such a teleoperation system 180 or through control of such a teleoperation system 180. In one or more embodiments, this teleoperation represents distance operation of a robot or robot appendage, distance surgical operations, devices that provide realism through virtual simulations, and gaming interfaces. One or more of the elements of the teleoperation system 180 includes a processing device, such a specially configured processing device, processor, or computer that controls one or more operations of the teleoperation system 180. In an embodiment, such control could be implemented through computer readable code embodied on a non-transitory computer readable medium, as only an example.

The 3D tactile sensation transferring apparatus 100 of FIGS. 1A and 1B, for example, will now be described in greater detail with reference to FIG. 2.

FIG. 2 illustrates an exploded perspective view of a 3D tactile sensation transferring apparatus 100, according to one or more embodiments.

The stationary unit 130 may be an enclosure that includes, in an inside of the enclosure, a supporting space to accommodate the frame 120 and thus, control the scope or extent of motion of the frame 120 in horizontal directions, e.g., in back and forth directions, along an X-axis direction, and/or left and right directions, along a Y-axis direction.

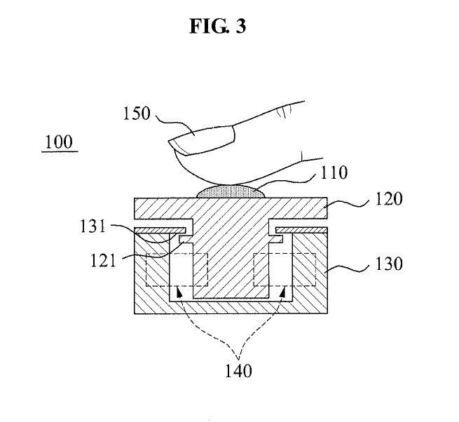

The frame 120 may be accommodated in the enclosure of the stationary unit 130 so as to prevent the frame 120 from separating from the stationary unit 130. For example, the frame 120 and/or the interior of the stationary unit 130 may be configured to limit the scope of motion of the frame 120 in up and down directions, i.e., along a Z-axis direction, such as shown in FIG. 3.

FIG. 3 illustrates a cross-sectional view of a 3D tactile sensation transferring apparatus 100, according to one or more embodiments.

During an assembly state when a moveable unit is accommodated in the stationary unit 130, a protrusion 121 of the frame 120 will be caught by a protrusion 131 on a top of the stationary unit 130, and thus, the frame 120 may be prevented from becoming separated from the stationary unit 130 during tactile sensation provision by the interoperation of the stationary unit 130 and the frame 120.

The contact surface 110 may be controlled to transfer a tactile sensation through by a frictional force between the skin of the finger 150 and the contact surface 110. Referring to FIG. 3, the contact surface 110 can be controlled to protrude upward, and may transfer to the skin of the finger 150 an up and down motion, that is, in a Z-axis direction.

The 3D tactile sensation transferring apparatus 100 may include an actuator 140 that moves the moveable unit in at least one direction.

The actuator 140 of FIG. 3 may be located along both sides of the frame 120 along a same axis, for example, to move the frame 120 in the respective direction, e.g., in the back and forth X-axis direction and/or in the left and right Y-axis direction.

Another actuator is arranged along a bottom side of the frame 120 and the stationary unit 130 and pushes the frame 120 in an up and down Z-axis direction.

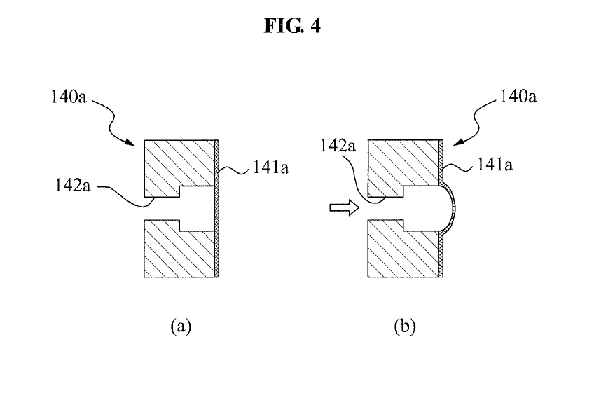

The actuator 140 may be variously embodied, as described in one or more embodiments of FIGS. 4 through 9, noting that alternative horizontal and vertical force generators are equally available. Additionally, though motion of the frame 120 may be along the described X- and Y-axes, the number of non-vertical axes, i.e., non-orthogonal axes, is not limited to two axes and they may equally include more than two non-vertical axes that are not orthogonal to each other and/or plural horizontally different arranged non-vertical axes. Still further, embodiments may include such non-vertical axes and one or more axes arranged to provide a vertical component of a tactile force vector, and these one or more axes arranged to provide the vertical component may actually be plural non-vertical axes, distinct from the non-vertical axes arranged to provide the horizontal component of the tactile force vector, as only an example.

FIG. 4 illustrates an actuator of a 3D tactile sensation transferring apparatus that controls the provision of the tactile force vector by controlling air pressure within a chamber, e.g., of the stationary unit 130, that causes movement of the frame 120, according to one or more embodiments.

An actuator 140a may push the frame 120 within the enclosure of the stationary unit 130 in a predetermined direction, by controlling the air pressure applied to plural actuators 140a.

In an embodiment, a frame of the actuator 140a may include an air filling pipe 142a, and one side of the air filling pipe 142a may be sealed by an elastic unit 141a, for example.

A 3D force vector of a 3D force that moves a movable unit, such as the frame 120, to transfer a 3D tactile sensation may be provided by a controller, such as generated by the teleoperation controller 160 of FIG. 1B. The controller may initiate the pushing of air into the air filling pipe 412a through an air compressor controlled by the controller, e.g., through a controller input signal, to increase or decrease the air pressure applied to the elastic unit 141a.

The elastic unit 141a, a portion of which may be fixed on a frame of the actuator 140a and a remaining portion of which is exposed to the pushed air, may be inflated from a state of (a) of FIG. 4 to a state of (b) of FIG. 4, and thus, force may be transferred to the frame 120 through the inflated portion of the elastic unit 141a. Accordingly, the frame 120 may move in a direction of the transferred force.

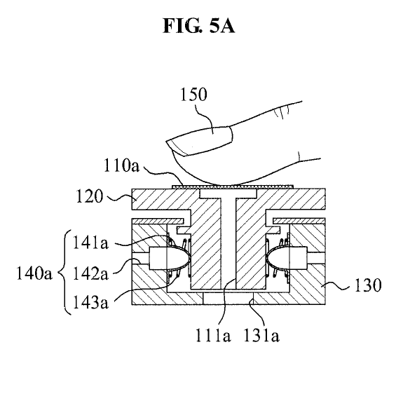

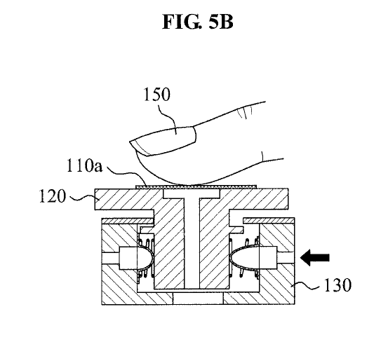

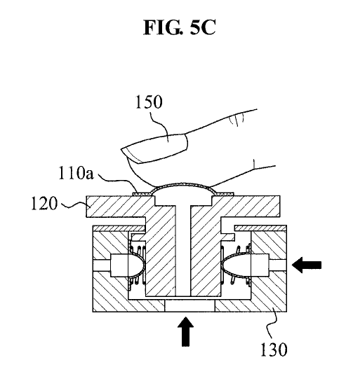

FIGS. 5A, 5B, and 5C illustrate a process where the frame 120 of the moveable unit of the 3D tactile sensation transferring apparatus 100 is moved by an actuator, such as the actuator 140a of FIG. 4, according to one or more embodiments.

The actuator 140a of FIG. 4 is in a state where the actuator 140a is capable of moving the frame 120 in a direction of back and forth, that is, an X-axis direction, in the stationary unit 130. There are plural actuators so the frame 120 is capable of being directed in plural different directions at the same time, e.g., in two or more respective dimensions.

Referring to FIG. 5A, and again referring to actuator 140a as only an example, two opposing actuators 140a may include respective elastic bodies 143a that provide countering restoring forces to enable the frame 120 to maintain an equilibrium position when no forces or equal forces are transferred by the respective actuators 140a of the 3D tactile sensation transferring apparatus 100.

In such an embodiment, as noted, each actuator 140a may be arranged to be symmetric with respect to the frame 120, e.g., to control the position of the frame 120 along respective direction axes within the stationary unit 130.

Referring to FIG. 5B, when an input signal for moving the frame 120 in an X-axis direction is generated, e.g., by the teleoperation controller 160, the actuator may be activated, representing the air pressure in the actuator 140a being increased or decreased, e.g., in response to the input signal, causing the frame 120 to move in the X-axis direction, and thus, the motion of the frame 120 may generate a tactile stimulation through a contact surface 110a that is in contact with the finger 150. Any applied increase in air pressure and decrease in air pressure to and/or within respective actuators 140a may generate respective push and pull forces, though embodiments may include generating only push forces or only pull forces. Similar movement operations are available in the Y-axis direction.

Referring to FIG. 5C, when an input signal initiates a moving of the frame 120 along a Z-axis, e.g., in addition to actuator controlled movement along the X- and/or Y-axes, is generated by the controller, the actuator 140a of the X-axis direction, for example, may generate, using such provided increased or decreased air pressures, with a tactile stimulation in the X-axis direction, and the actuator of the Z-axis direction may use respectively increased or decreased air pressure to directly move the contact surface 110a in the Z-axis direction to generate a tactile stimulation in the Z-axis direction.

In an embodiment, the actuator of the Z-axis direction may utilize a configuration of the stationary unit 130, and may directly inflate the contact surface 110a in the Z-axis direction upon a controlled increasing of the air pressure through an air filling pipe 131a of a bottom side of the stationary unit 130 and an air filling pipe 111a, which is connected with the air filling pipe 131a and located inside the frame 120 connected with the air filling pipe 131a. Accordingly, depending on embodiment, the actuator for the Z-axis may move the entire frame 120 in the Z-axis direction and/or force the contact surface 110a upward in the Z-axis direction, to provide the tactile stimulation in the Z-axis direction.

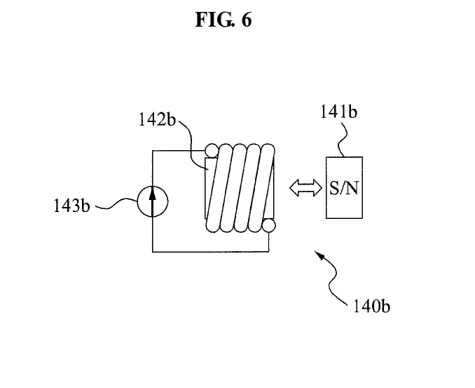

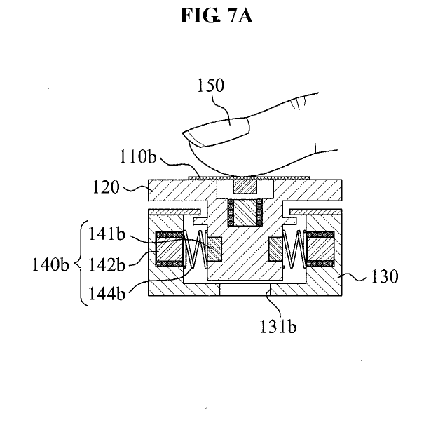

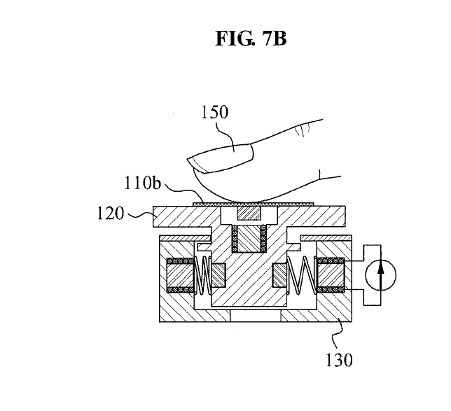

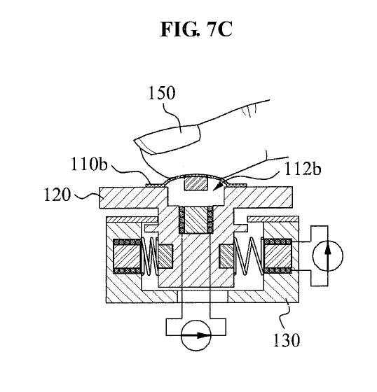

Although examples of an actuator using changes in air pressure have been described above, example embodiments are not limited thereto. For example, the actuator 140 may use an electromagnetic force and the like. Additionally, actuators for each respective axis may use different force generating actuators, such as air pressure, electromagnetic forces, and/or the below mentioned actuators that use piezo-electric elements for force generation. Examples of an actuator using the electromagnetic force will now be described with reference to FIGS. 6 and 7.

FIG. 6 illustrates an actuator 140b of a 3D tactile sensation transferring apparatus, the actuator being embodied by a solenoid, according to one or more embodiments.

The actuator 140b may include a solenoid 142b, a permanent magnet 141b, and a current source 143b that provides a current to the solenoid 142b, for example.

When an input signal initiates movement of a frame of the moveable unit is received, e.g., from a controller such as the teleoperation controller 160, the current source 143b may be controlled to provide a current to the solenoid 142b, and the current may produce electromagnetic forces of attraction and repulsion, between the solenoid 142b and the permanent magnet 141b.

The attractive force or repulsive force may accordingly attract or repulse the frame of the moveable unit, e.g., the frame 120, and thus, may generate motion in a desired direction according to the arrangement of the solenoid 142b and the permanent magnet 141b.

FIGS. 7A, 7B, and 7C illustrate a process where a moveable unit, e.g., the frame 120, of a 3D tactile sensation transferring apparatus is moved by an electromagnetic actuator, such as the actuator 140b of FIG. 6, according to one or more embodiments.

The actuator 140b may include an elastic body 144b that provides a restoring force, to maintain an equilibrium or wait state of FIG. 7A. The operation of the elastic body 144b may be similar to the elastic body 144a of FIG. 5A, and accordingly further discussion will be omitted.

When an input signal is received during the wait state, the actuator 140b is considered as being activated, with the current source 143b being controlled, e.g., by the teleoperation controller 160 of FIG. 1B, to provide a current to the solenoid 412b, which generates an electromagnetic force of attraction or repulsion, led by the current between the solenoid 142b and the permanent magnetic 141b, and which ultimately move the frame 120 in the stationary unit 130.

Referring to FIG. 7B, when the frame 120 is caused to move in an X-axis direction, a motion in the X-axis direction is generated, and this motion is transferred to the finger 150 as a tactile stimulation through a contact surface 110b. Movement in the Y-axis direction and generation of corresponding tactile stimulation is similarly preformed.

Referring to FIG. 7C, a motion in a Z-axis direction, in addition to an X-axis direction, for example, is generated and is transferred to the finger 150 as a tactile stimulation.

Although examples of actuator 140 using a solenoid are illustrated, example embodiments are not limited thereto.

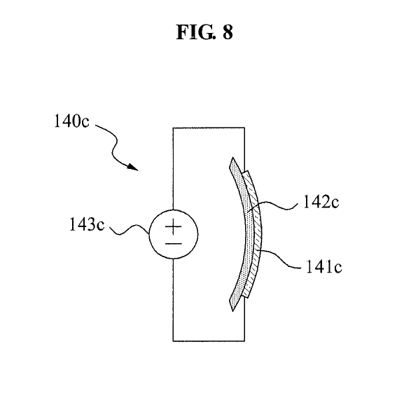

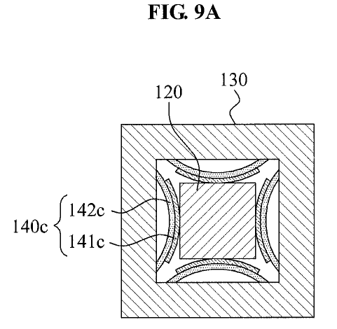

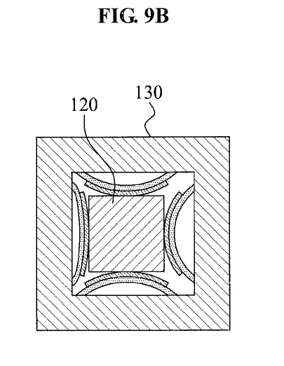

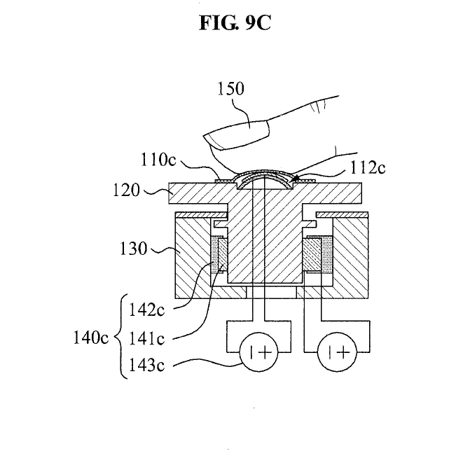

For example, the actuator 140 may be embodied by a bimorph using a piezoelectric element. Examples of an actuator using the bimorph will now be described with reference to FIGS. 8 and 9.

FIG. 8 illustrates an actuator 140c of a 3D tactile sensation transferring apparatus, the actuator 140c being embodied by a bimorph including a piezo-electric element, according to one or more embodiments.

The bimorph may be configured by a piezoelectric element layer 141c in a form of panel and an elastic panel layer 142c that is different from the piezoelectric element layer 141c, with the piezoelectric elements layer 141c and the elastic panel layer 142c being in contact with each other, for example.

In the above described state, when a voltage source 143c provides a voltage to the piezoelectric element layer 141c, e.g., under control of the teleoperation controller 160 of FIG. 1B, the whole bimorph may be bent by modulation of the piezoelectric element.

Accordingly, the bending may lead a tensile force in a predetermined direction.

FIGS. 9A, 9B, and 9C illustrate a process where a moveable unit, such as the frame 120, of a 3D tactile sensation transferring apparatus is moved by a piezoelectric element based actuator, such as actuator 140c of FIG. 8, according to one or more embodiments.

Referring to FIG. 9A, in a wait state, the frame of the movable unit is centrally fixed within the enclosure of the stationary unit 130, similar to the aforementioned equilibrium positions or states, with four bimorphs being particularly arranged along an X-axis direction and a Y-axis direction to support the frame 120.

Each of the four bimorph includes the piezoelectric element layer 141c and the elastic panel layer 142c, which are in contact with each other, and the wait state may represent the state when no voltage is applied to the respective piezoelectric element layers 141c.

Referring to FIG. 9B, representing an activation of the actuator 140c, when the voltage source 143c is controlled to provide a voltage to a bimorph in the X-axis direction in response to an input signal, e.g., by the teleoperation controller 160, the frame 120 of the stationary unit 130 is caused to MOW, as a bimorph in one direction becomes more bent than the same bimorph in the wait state. Thus, the bending of the bimorph may cause the frame 120 of the stationary unit 130 to move in the X-axis direction. The bending of respective bimorphs for the Y-axis produces similar movements of the frame 120 of the stationary unit 130 to move in the Y-axis direction.

In this example, each bimorph may provide a restoring force and thus, an elastic body similar to the elastic bodies 144a and 144b of FIGS. 5A and 7A, respectively, may not be separately included in the actuator 140c to provide the restoring/equilibrium force.

Referring to FIG. 9C, a bimorph 112c is separately included beneath a contact surface 110c for motion in a Z-axis direction relative to the stationary unit 130, and may directly generate the motion in the Z-axis direction to transfer a tactile stimulation to the finger 150 from the top surface of the frame 120. An alternative arrangement could place the bimorph 112c below frame 120 within the enclosure of the stationary unit 130 to move the frame 120 upward in the Z-axis direction.

Although various examples of the actuator 140 are described, various additional or alternative applications may be made to such actuators 140 and a 3D tactile sensation transferring apparatus 100 of FIG. 1A and/or teleoperation system 180 of FIG. 1B, according to one or more embodiments without departing from the principles and spirit of the disclosure, the scope of which is defined by the claims and their equivalents.

Therefore, in one or more embodiments, any apparatus, system, and unit descriptions herein include one or more hardware devices and/or hardware processing elements/devices. In one or more embodiments, any described apparatus, system, and unit may further include one or more desirable memories, and any desired hardware input/output transmission devices, as only examples. Further, the term apparatus should be considered synonymous with elements of a physical system, not limited to a device, i.e., a single device at a single location, or enclosure, or limited to all described elements being embodied in single respective element/device or enclosures in all embodiments, but rather, depending on embodiment, is open to being embodied together or separately in differing devices or enclosures and/or differing locations through differing hardware elements.

In addition to the above described embodiments, embodiments can also be implemented through computer readable code/instructions in/on a non-transitory medium, e.g., a computer readable medium, to control at least one processing element/device, such as a processor, computing device, computer, or computer system with peripherals, to implement any above described embodiment. The medium can correspond to any defined, measurable, and tangible structure permitting the storing and/or transmission of the computer readable code. Additionally, one or more embodiments include the at least one processing element or device.

The media may also include, e.g., in combination with the computer readable code, data files, data structures, and the like. One or more embodiments of computer-readable media include magnetic media such as hard disks, floppy disks, and magnetic tape; optical media such as CD ROM disks and DVDs; magneto-optical media such as optical disks; and hardware devices that are specially configured to store and/or perform program instructions, such as read-only memory (ROM), random access memory (RAM), flash memory, and the at least one processing device, respectively. Computer readable code may include both machine code, such as produced by a compiler, and files containing higher level code that may be executed by the computer using an interpreter, for example. The media may also be any defined, measurable, and tangible elements of one or more distributed networks, so that the computer readable code is stored and/or executed in a distributed fashion. In one or more embodiments, such distributed networks do not require the computer readable code to be stored at a same location, e.g., the computer readable code or portions of the same may be stored remotely, either stored remotely at a single location, potentially on a single medium, or stored in a distributed manner, such as in a cloud based manner. Still further, as noted and only as an example, the processing element could include a processor or a computer processor, and processing elements may be distributed and/or included in a single device of a system embodiment or processing element controlled by computer readable code to implement any method or medium embodiment, as only an example. There may be more than one such processing element and/or processing elements with plural distinct processing elements, e.g., a processor with plural cores, in which case one or more embodiments would include hardware and/or coding to enable single or plural core synchronous or asynchronous operation.

The computer-readable media may also be embodied in at least one application specific integrated circuit (ASIC) or Field Programmable Gate Array (FPGA), as only examples, which execute (processes like a processor) program instructions.

While aspects of the present invention has been particularly shown and described with reference to differing embodiments thereof, it should be understood that these embodiments should be considered in a descriptive sense only and not, for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A three-dimensional (3D) tactile sensation transferring apparatus, the apparatus comprising:
a stationary element;
a movable element being accommodated within an enclosure of the stationary element, and configured to move along at least one non-orthogonal axis relative to a surface of a body to transfer a horizontal component of a multi-dimensional force vector, as a tactile sensation, to the surface of the body when the surface of the body is in contact with the movable element; and
an actuator configured in the stationary element and to apply a movement force to the movable element along the one non-orthogonal axis when the actuator is activated.

2. The apparatus of claim 1, wherein the actuator further comprises an elastic body that provides a restoring force to the movable element to force the moveable element toward an equilibrium position relative to an interior of the stationary element at least when the actuator is not activated.

3. The apparatus of claim 1, wherein the actuator applies the movement force along the one non-orthogonal axis according to changes in air pressure within the actuator.

4. The apparatus of claim 1, wherein the actuator is a solenoid generating an electromagnetic force through interaction between the actuator and the movable element to apply the movement force to the moveable element along the one non-orthogonal axis.

5. The apparatus of claim 1, wherein the actuator is a bimorph including a piezo-electric element layer whose change in shape controls the application of the movement force to the moveable element along the one non-orthogonal axis.

6. The apparatus of claim 1, wherein movement of the movable element within the enclosure of the stationary element is representative of a three-dimensional (3D) force vector of a feedback signal representing a load being applied to the body by a teleoperator, including the stationary element, moveable element, and the actuator, during a teleoperation.

7. The apparatus of claim 6, further comprising:
a teleoperation controller to control operation of plural actuators configured to apply respective movement forces to the movable element to transfer the 3D force vector, as the tactile sensation, to the surface of the body during the teleoperation; and
a kinaesthesia force applicator configured to apply kinaesthesia forces, distinct from the 3D force vector, by the teleoperator to the body during the teleoperation.

8. The apparatus of claim 1, wherein the actuator comprises:
a first actuator configured to apply a first movement force to the movable element along an X-axis direction horizontal relative the surface of the body, upon respective activation;
a second actuator configured apply a second movement force to the movable element along a Y-axis direction horizontal relative to the surface of the body, upon respective activation; and
a third actuator configured to apply a third movement force to the movable element along a Z-axis direction orthogonal to the X- and Y-axes, upon respective activation.

9. The apparatus of claim 8, further comprising:
a teleoperation controller to control operation of a plurality of the first, second, and third actuators configured to apply respective movement forces to respective movable elements, each moveable element to transfer a respective 3D force vector as a respective tactile sensation to different surfaces of the body by a teleoperator, including the plurality of first, second, and third actuators, during the teleoperation; and
a kinaesthesia force applicator configured to apply kinaesthesia forces, distinct from each of the 3D force vectors, by the teleoperator to the body during the teleoperation.

10. A three-dimensional (3D) tactile sensation transferring method of a 3D tactile sensation transferring apparatus comprising a stationary element, a movable element being accommodated within an enclosure of the stationary element, and configured to move along at least one non-orthogonal axis relative to a surface of a body to transfer a horizontal component of a multi-dimensional force vector, as a tactile sensation, to the surface of the body when the surface of the body is in contact with the movable element, and an actuator configured in the stationary element and to apply a movement force to the movable element along the one non-orthogonal axis when the actuator is activated, the method comprising:
activating the actuator; and
moving the moveable element based upon a movement force applied by the actuator to the moveable element in the direction of the one non-orthogonal axis upon activation of the actuator.

11. The method of claim 10, further comprising:
providing a restoring force to the movable element, using an elastic body included in the actuator, to force the moveable element toward an equilibrium position relative to an interior of the stationary element at least when the actuator is not activated.

12. The method of claim 10, wherein the moving of the moveable element comprises applying the movement force to the movable element along the one non-orthogonal axis according to changes in air pressure within the actuator.

13. The method of claim 10, wherein the moving of the moveable element comprises applying the movement force to the movable element along the one non-orthogonal axis using a solenoid electromagnetic force generated through interaction between the actuator and the movable element.

14. The method of claim 10, wherein the moving of the moveable element comprises moving the movable element using a bimorph including a piezo-electric element layer whose change in shape controls the application of the movement force to the moveable element along the one non-orthogonal axis.

15. The method of claim 10, wherein movement of the movable element within the enclosure of the stationary element is representative of a three-dimensional (3D) force vector of a feedback signal representing a load being applied to the body by a teleoperator, including the stationary element, the moveable element, and the actuator, during a teleoperation.

16. The method of claim 15, further comprising:
controlling operation of plural actuators configured to apply respective movement forces to the movable element to transfer the 3D force vector, as the tactile sensation, to the surface of the body during the teleoperation; and
applying kinaesthesia forces, distinct from the 3D force vector, by the teleoperator to the body during the teleoperation.

17. The method of claim 10, further comprising:
controlling an application of a first movement force to the movable element along an X-axis direction horizontal relative the surface of the body;
controlling an application of a second movement force to the movable element along a Y-axis direction horizontal relative to the surface of the body; and
controlling an application of a third movement force to the movable element along a Z-axis direction orthogonal to the X- and Y-axes.

18. The method of claim 17, further comprising:
controlling operation of a plurality of the first, second, and third actuators configured to apply respective movement forces to respective movable elements, each moveable element to transfer a respective 3D force vector as a respective tactile sensation to different surfaces of the body by a teleoperator, including the plurality of first, second, and third actuators, during the teleoperation; and
applying kinaesthesia forces, distinct from each of the 3D force vectors, by the teleoperator to the body during the teleoperation.

19. A non-transitory computer-readable medium comprising computer readable code to control at least one processing device to implement the method of claim 8.
